(19) United States
(12) Patent Application Publication
(10) Pub. No.: US 2017/0307025 A1
(43) Pub. Date: Oct. 26, 2017

(54) Shaft Coupling Guard

(71) Applicant: Ameridrives International LLC, Erie, PA (US)

(72) Inventors: Jack Eric Pederson, Greeny Bay, WI (US); Leon Vang Xiong, Greeny Bay, WI (US)

(21) Appl. No.: 15/133,249

(22) Filed: Apr. 20, 2016

(51) Int. Cl. F16D 3/84

(52) U.S. Cl. CPC F16D 3/84

(57) ABSTRACT

A guard for a power transmission coupling includes first and second housing members extending longitudinally along corresponding first and second axes and each having first and second longitudinal ends. The first longitudinal end of the first housing member defines an opening configured to receive one of a drive shaft and a driven shaft of the power transmission coupling while the first longitudinal end of the second housing member defines an opening configured to receive the other shaft. The second longitudinal end of the second housing member is configured to be telescoped within the second longitudinal end of the first housing member and the second housing member is movable relative to the first housing member in the direction of the first axis. A plurality of guides are disposed between and couple the first and second housing members and are configured to allow relative movement of the first and second housing members.

### BACKGROUND OF THE INVENTION

### a. Field of the Invention

This disclosure relates to a guard for a shaft coupling in which a drive shaft is coupled to a driven shaft. In particular, the disclosure relates to a guard that provides protection to nearby individuals and equipment, but also facilitates access to the shaft coupling and surrounding equipment for maintenance.

### b. Background Art

In power transmission assemblies in which a drive shaft from a motor or other power source is coupled to a driven shaft used to rotate a component such as a pump or gear, the drive shafts and driven shafts may be, or become, misaligned. Therefore, the shafts are coupled using shaft couplings such as universal joints that transmit torque between the shafts, but permit some degree of misalignment between the shafts. Shaft couplings may fail under a variety of conditions including extreme misalignment of the shafts and corrosion or other wear in the couplings. Because of the large loads encountered in power transmission assemblies, high shaft rotational speeds have the potential to result in injury to nearby individuals and/or damage to nearby equipment. To prevent such injury and damage, guards are employed that surround all or part of the shafts and shaft coupling.

Shaft couplings and surrounding equipment require regular maintenance both during operation and when not in operation. During operation, for example, it is often necessary to monitor bearing temperatures and to investigate fluid leaks as well as to clean surrounding equipment and areas. When the shaft coupling is not in operation, maintenance may include applying lubrication to, changing lubrication in, repairing, or replacing components of the shaft coupling or surrounding equipment. Conventional guards for shaft couplings make it difficult to perform regular maintenance activities. Many guards that surround the shaft coupling are custom fabricated, made of relatively lightweight sheet metal, and are also large and cumbersome. These characteristics frequently result in distortion of the surfaces to which the guards are mounted and make it difficult to remove and reinstall the guards to perform required maintenance. This difficulty leads to reduced maintenance, excessive downtime of the power transmission assembly when maintenance is performed and, at times, discard of the shaft guards and a resulting reduction in safety. In some cases, guards that surround the shaft couplings are eschewed in favor of fences that limit access to the shaft coupling and surrounding equipment. Although such fencing permits easier access to the coupling and surrounding equipment when the power transmission assembly is not in operation, maintenance generally cannot be performed when the power transmission assembly is operating.

The inventors herein have recognized a need for a guard for a shaft coupling that will minimize and/or eliminate one or more of the above-identified deficiencies.

### BRIEF SUMMARY OF THE INVENTION

This disclosure relates to a guard for a shaft coupling in which a drive shaft is coupled to a driven shaft. In particular, the disclosure relates to a guard that provides protection to nearby individuals and equipment, but also facilitates access to the shaft coupling and surrounding equipment for maintenance.

A guard for a shaft coupling that couples a drive shaft disposed about a rotational axis and a driven shaft in accordance with one embodiment of the present teachings includes a first housing member extending longitudinally along a first axis and having first and second longitudinal ends. The first longitudinal end defines an opening configured to receive one shaft of the drive shaft and the driven shaft. The guard further includes a second housing member extending longitudinally along a second axis and having first and second longitudinal ends. The first longitudinal end of the second housing member defines an opening configured to receive another shaft of the drive shaft and the driven shaft. The second longitudinal end of the second housing member is configured to be telescoped within the second longitudinal end of the first housing member. The second housing member is movable relative to the first housing member in the direction of the first axis. The guard further includes a plurality of guides disposed between and coupling the first and second housing members and configured to allow relative movement of the first and second housing members.

A guard for a shaft coupling that couples a drive shaft disposed about a rotational axis and a driven shaft in accordance with another embodiment of the present teachings includes a first housing member extending longitudinally along a first axis and having first and second longitudinal ends. The first longitudinal end defines an opening configured to receive one shaft of the drive shaft and the driven shaft. The guard further includes a second housing member extending longitudinally along a second axis and having first and second longitudinal ends. The first longitudinal end of the second housing member defines an opening configured to receive another shaft of the drive shaft and the driven shaft. The second longitudinal end of the second housing member is configured to be telescoped within the second longitudinal end of the first housing member. The second housing member is movable relative to the first housing member in the direction of the first axis. The guard further includes means for guiding movement of the second housing member within the first housing member.

A guard for a shaft coupling in accordance with the present teachings is advantageous relative to conventional guards for shaft couplings. In particular, the guards described herein provide protection to nearby individuals and equipment, but also facilitate access to the shaft coupling and surrounding equipment for maintenance. The guards provide easy access to shaft couplings during operation of power transmission assemblies as well as during downtime for the assemblies. As a results the guards are more likely to be used (thereby reducing risks associated with the power transmission assemblies), facilitate regular maintenance on the shaft couplings, and result in less downtime of power transmission assemblies during maintenance.

The foregoing and other aspects, features, details, utilities, and advantages of the invention will be apparent from reading the following detailed description and claims, and from reviewing the accompanying drawings illustrating features of this invention by way of example.

### BRIEF DESCRIPTION OF THE DRAWINGS

FIGS. 1-2 are perspective views of a guard for a shaft coupling in accordance with one embodiment of the present teachings.

FIG. 3 is a perspective view of a portion of the guard of FIGS. 1-2.

FIG. 4 is a side view of the portion of the guard shown in FIG. 3.

FIG. 5 is a top view of the portion of the guard shown in FIG. 3.

FIG. 6 is a top view of a portion of an inner housing member of the guard of FIGS. 1-2.

FIG. 7 is a side view of the portion of the inner housing member shown in FIG. 8.

FIG. 8 is an end view of the portion of the inner housing member shown in FIG. 6.

FIGS. 9-10 are perspective views of a shroud that may be disposed about a portion of the inner housing member of the guard of FIGS. 1-2.

FIG. 11 is a top view of a portion of an outer housing member of the guard of FIGS. 1-2.

FIG. 12 is a side view of the portion of the outer housing member shown in FIG. 11.

FIG. 13 is an end view of the portion of the outer housing member shown in FIG. 11.

FIG. 14 is a perspective view of a connector of the guard of FIGS. 1-2.

FIG. 15 is a perspective view of a guide of the guard of FIGS. 1-2.

FIG. 16 is a cross-sectional view of an alternative embodiment of a guide for the guard in accordance with the present teachings.

FIG. 17 is a perspective view of another embodiment of a guide for the guard in accordance with the present teachings.

### DETAILED DESCRIPTION OF THE INVENTION

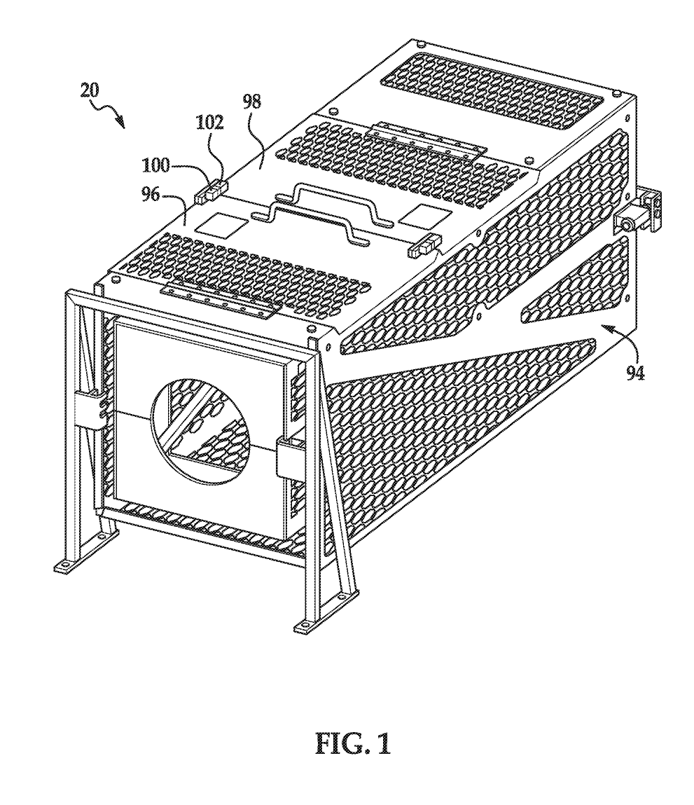

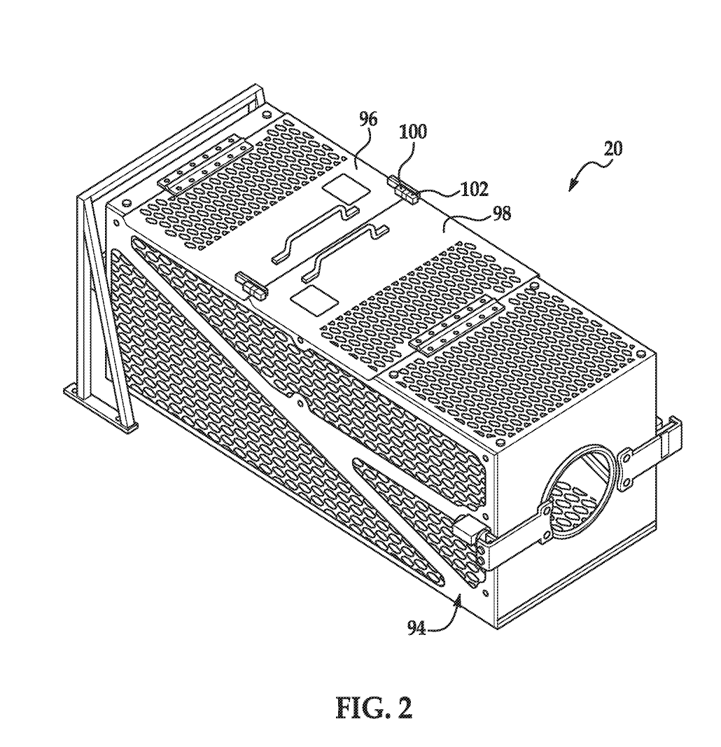

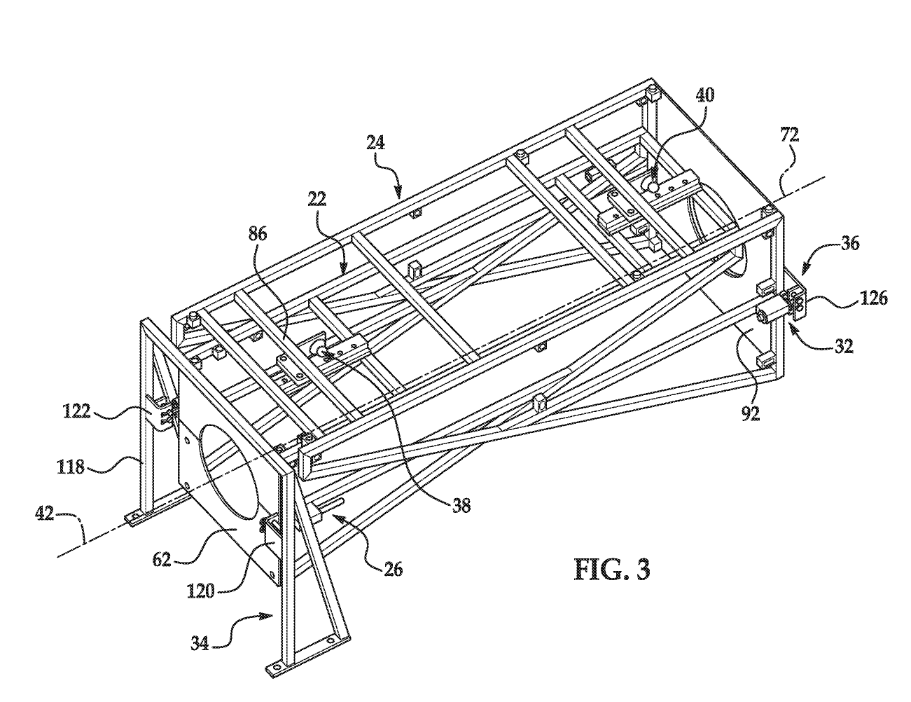

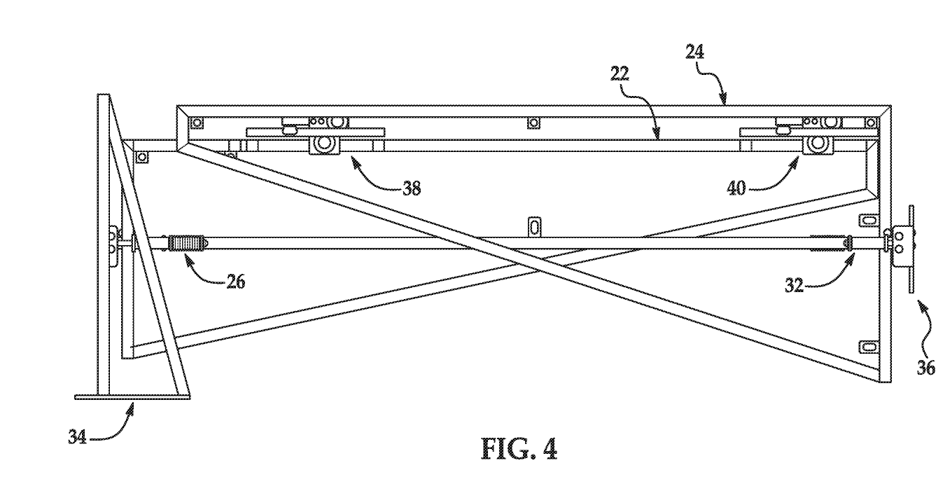

Referring now to the drawings wherein like reference numerals are used to identify identical components in the various views, FIGS. 1-2 illustrates a guard 20 for a shaft coupling of a power transmission assembly in accordance with one embodiment of the present teachings. Referring to FIGS. 3-5, guard 20 may include a pair of housing members 22, 24, means, such as connectors 26, 28 and 30, 32, and coupling interfaces 34, 36, for coupling housing members 22, 24 to fixed support structures (not shown) and means, such as guides 38, 40, for guiding movement of the housing member 22 within, and relative to, housing member 24.

Housing members 22, 24 are provided to at least partially enclose a shaft coupling (not shown) including a drive shaft disposed about a rotational axis and a driven shaft coupled to the drive shaft. Each of members 22, 24 is configured to receive one longitudinal end of a corresponding one of the drive shaft or driven shaft and to at least partially enclose the coupling interface between the two shafts. Member 22 has dimensions that are smaller than those of member 24 such that member 22 may be received within member 24 and, in particular, telescoped within member 24 as discussed in greater detail below.

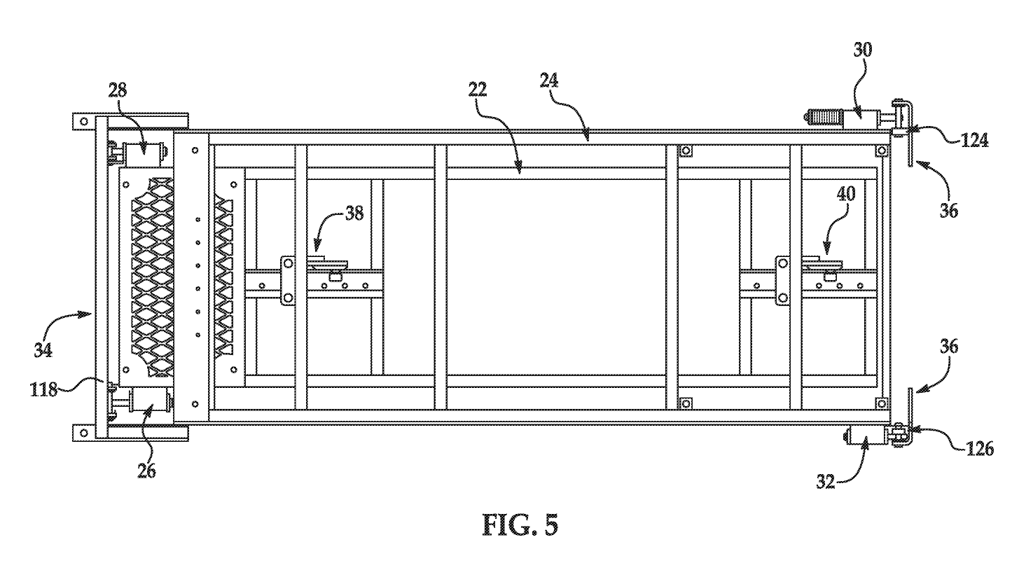

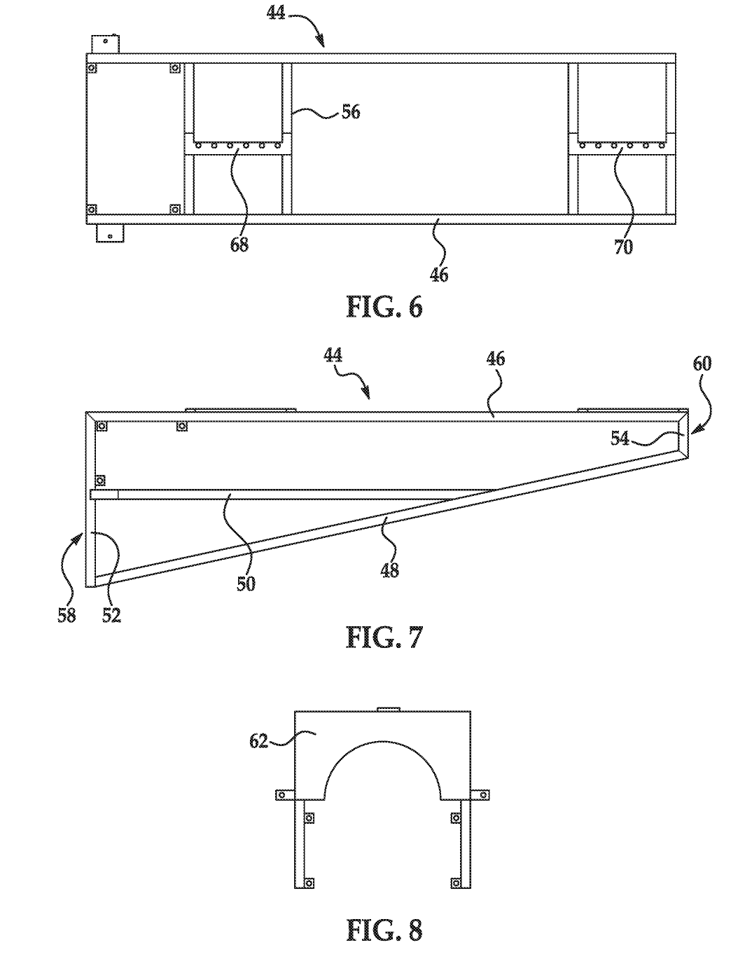

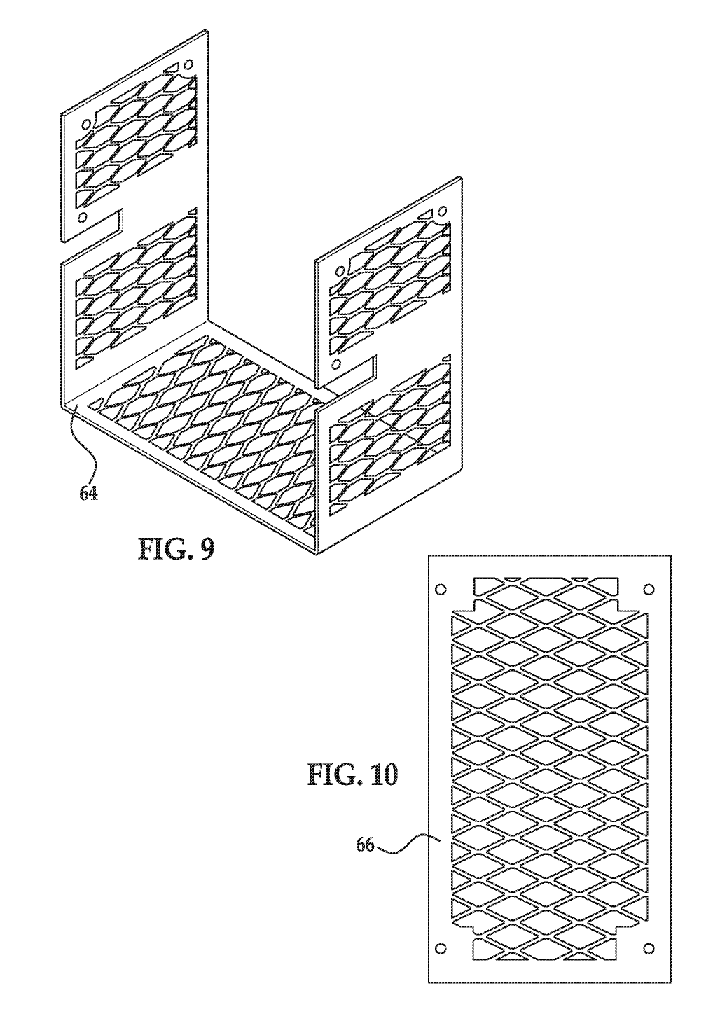

Referring to FIG. 3, housing member 22 extends longitudinally along an axis 42 and may be centered about axis 42. The axis 42 may be parallel to, and may be coincident with, the rotational axis of the drive shaft. Referring to FIGS. 6-8 member 22 may include a frame 44 made from conventional metals or metal alloys. Frame 44 may include a plurality of members that are joined together using conventional fasteners such as screws, bolts, welds or adhesives. The members may include pairs of upper longitudinal members 46, a lower longitudinal members 48, intermediate longitudinal members 50, proximal vertical members 52, distal vertical members 54, and one or more lateral or cross members 56 extending between upper longitudinal members 46. The length of proximal vertical members 52 may be greater than the length of distal vertical members 54 such that lower longitudinal members 48 are oriented at an angle relative to upper longitudinal members 46 and the height of housing member 22 varies along the length of housing member 22--decreasing moving from one longitudinal end 58 of housing member 22 to an opposite longitudinal end 60 of housing member 22. The three sided configuration of frame 44 of housing member 22 allows frame 44 to be lowered vertically over the shaft coupling during installation and the shape of frame 44 reduces costs relative to a box-shaped frame. It should be understood, however, that the shape of frame 44 may vary including being box-shaped or in the form of a rectangular prism. Intermediate longitudinal members 50 may extend parallel to upper longitudinal members 48 and may be configured to mount connectors 26, 28. Housing member 22 may further include a cover 62 at end 56 of housing member 22 through which one of the drive shaft or driven shaft extends. Referring to FIG. 8, in some embodiments cover 62 may be semicircular or have another open shape such that housing member 22 is disposed about only a portion of a perimeter of the shaft. Referring to FIG. 3, in other embodiments, the cover 62 may have an annular or other closed shape such that housing member 22 is disposed about the entirety of the perimeter of the shaft. Referring to FIGS. 5 and 9-10, housing member 22 may also include a cage or shroud mounted to frame 44 and enclosing a portion of member 22 proximate end 58 of member 22. In the illustrated embodiment, the cage have one member 64 that covers the bottom and two sides of housing member 22 and a member 66 that covers the top of housing member 22. Referring again to FIG. 6, housing member 22 may further include rails 68, 70 for a purpose described below. Rails 68, 70 may extend between a pair of cross members 56 and may extend parallel to axis 42 and/or longitudinal members 46, 48, 50 of frame 44 of housing member 22.

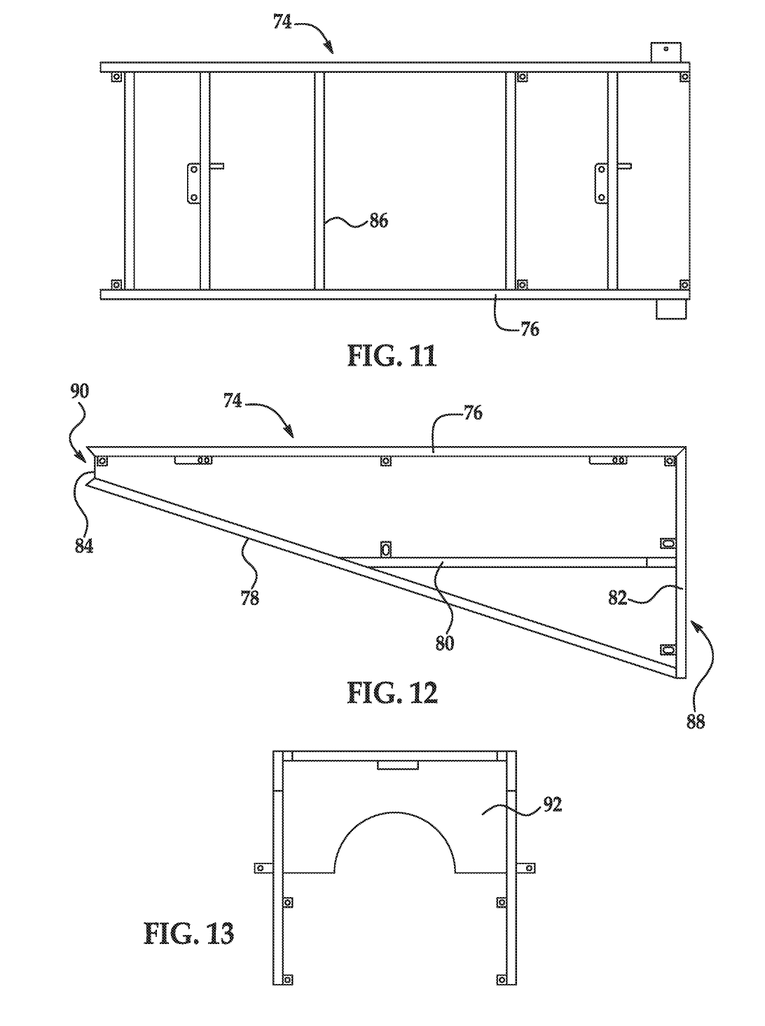

Referring to FIG. 3, housing member 24 extends longitudinally along an axis 72 and may be centered about axis 72. The axis 72 may be parallel to, and may be coincident with, the rotational axis of the drive shaft as well as axis 42. Referring to FIGS. 11-13, member 24 may include a frame 74 made from conventional metals or metal alloys. The dimensions of frame 74 are such that housing member 22 may be telescoped within housing member 24. Frame 74 may include a plurality of members that are joined together using conventional fasteners such as screws, bolts, welds or adhesives. The members may include pairs of upper longitudinal members 76, lower longitudinal members 78, intermediate longitudinal members 80, proximal vertical members 82, distal vertical members 84, and lateral or cross members 86 extending between upper longitudinal members 76. The length of proximal vertical members 82 may be greater than the length of distal vertical members 84 such that lower longitudinal members 78 are oriented at an angle relative to upper longitudinal members 76 and the height of housing member 24 varies along the length of housing member 24—decreasing moving from one longitudinal end 88 of housing member 24 to an opposite longitudinal end 90 of housing member 24. The three sided configuration of frame 74 of housing member 24 again allows frame 74 to be lowered vertically over the shaft coupling during installation and the shape of frame 74 reduces costs relative to a box-shaped frame. It should again be understood, however, that the shape of frame 74 may vary including being box-shaped or in the form of a rectangular prism. Intermediate longitudinal members 80 may extend parallel to upper longitudinal members 76 and may be configured to mount connectors 30, 32. Referring to FIG. 13, housing member 24 may further include a cover 92 at end 88 of housing member 24 through which one of the drive shaft or driven shaft extends. In some embodiments cover 92 may be semicircular or have another open shape such that housing member 24 is disposed about only a portion of a perimeter of the shaft. Referring to FIG. 3, in other embodiments, cover 92 may have an annular or other closed shape such that housing member 24 is disposed about the entirety of the perimeter of the shaft. Referring to FIGS. 1-2, housing member 24 may include a cage 94 or shroud mounted to frame 74 and enclosing a portion or all of member 24. Cage 94 may be comprised of multiple members joined together including two doors 96, 98 formed on a top side of housing member 24 that can be moved relative to the other members of cage 94 (e.g., by rotation about a hinge or by removal of fasteners joining the doors to the other members of cage 94) to provide access to the shaft coupling. When access is not required, the doors 96, 96 may be secured in place by, for example, inserting pins in aligned brackets 100, 102. Referring again to FIGS. 3, cross members 86 may support guides 38, 40 as described in more detail below.

Connectors 26, 28 and 30, 32 and coupling interfaces 34 and 36 are provided to couple housing members 22, 24, respectively, to fixed structures located proximate the shaft coupling and guard. It should be understood that “fixed” in this context refers to a structure that is fixed against movement relative to a corresponding drive shaft or driven shaft of the shaft coupling as opposed to being fixed against movement generally. The structure may comprise, for example, a frame or housing or other structure from which the drive shaft or driven shaft extends (e.g., a motor, pump or gearbox housing). Connectors 26, 28 and 30, 32, as well as coupling interfaces 34, 36, may be disposed at or near ends 58, 88 of housing members 22, 24, respectively, and are generally located nearer to ends 58, 88, of housing members 22, 24 than ends 60, 90 of housing members 22, 24. Because of the telescoping relationship of housing members 22, 24 the connectors 26, 28 or 30, 32 for one of housing members 22, 24 may be disconnected from the coupling interface 34, 36 and the fixed structure to which they are attached and the corresponding housing member 22 or 24 moved relative to the other housing member 24 or 22 to allow access to the shaft coupling.

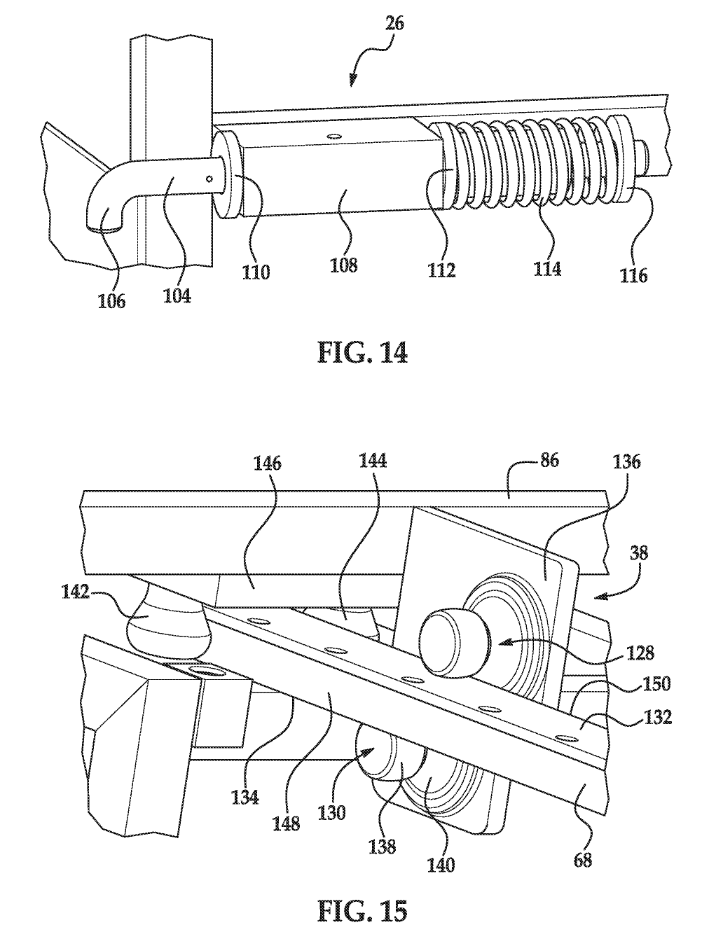

Referring to FIG. 14, connectors 26, 30 may each include a rod 104 with a hook 106 formed at one longitudinal end configured to engage a complementary structure in a corresponding coupling interface 34, 36. The rod 104 may extend through a housing 108 containing grease or another lubricant. Washers 110, 112 may be disposed about rod 104 on either side of housing 108. In accordance with one aspect of the illustrated embodiment, connectors 28, 32 may further include a compression spring 114 disposed about a portion of rod 104 extending out of housing 108 on an opposite side of housing 108 from hook 106. The spring 114 may be disposed between spring faces formed in washer 112 and another washer 116 disposed proximate a longitudinal end of rod 104. The spring 114 permits limited vertical and horizontal movement (in directions perpendicular to a corresponding axis 42 or 72) of a corresponding housing member 22 or 24 relative to the fixed structure to which it is mounted and permit some degree of relative movement between the fixed structures to which members 22, 24 are coupled to permit flexure during operation to adjust for angle changes between the drive and driven shafts of the shaft coupling during operation. A cotter pin or similar structure may extend through rod 104 or a flange may be formed in rod 104 on a side of housing 108 opposite spring 114 to limit movement of rod 104 in response to the force of spring 114. Connectors 28, 32 may be similar to connectors 26, 30, but without springs 114 and washers 112, 116 and with the longitudinal end of rod 104 opposite hook 106 fixed in position within housing 108. It should be understood that connectors 26, 28, 30, 32 could be formed in a variety of ways. In one alternative embodiment, for example, one or more leaf springs may extend between each housing member 22, 24 and a corresponding fixed structure and be fixed at each end to the housing member 22, 24 and fixed structure in a conventional manner.

Referring to FIGS. 3-5, coupling interfaces 34, 36 engage connectors 26, 28 and 30, 32, respectively, to couple housing members 22, 24, to fixed structures as described hereinabove. In the illustrated embodiment, the coupling interface 34 for housing member 22 includes a frame 118 configured to be mounted to a fixed structure and two coupling brackets 120, 122 fixed to frame 116. The brackets 120, 122 each include two spaced arms across which a pair of vertically spaced pins extend laterally. Hooks 106 on corresponding connectors 26, 28 extend between the two pins in a corresponding bracket 120, 122 and are disposed around at least a portion of one pin in the corresponding bracket 120, 122 with the spacing of the pins limiting or preventing disengagement of the hooks 106. The arms on one coupling bracket 120 may be spaced wider than the arms on bracket 122 to allow for movement of housing member 22. Coupling interface 36 for housing member 24 includes coupling brackets 124, 126 that may be similar to brackets 120, 122, respectively, but may be directly attached to a fixed structure. It should be understood that the structure of the coupling interfaces will vary depending on the configuration and functionality of the connectors and the configuration of the fixed structures.

Guides 38, 40 provide a means for guiding movement of housing member 22 within housing member 24. Guides 38, 40 are disposed between and couple housing members 22, 24 to one another and permit relative movement of members 22, 24. Guides 38, 40 are positioned to allow movement of one housing member 22 or 24 relative to the other housing member 24 or 22 at least along a corresponding axis 42 or 72. As described below, however, guides 38, 40 may also be configured to allow for relative movement of members 22, 24 in multiple degrees of freedom. In the illustrated embodiment, guides 38, 40 are mounted on cross members 86 of housing 24 and disposed proximate the lateral centerlines of housing members 22, 24 at the top of housing members 22, 24. Further, guide 38 is disposed between members 22, 24 nearer to end 58 of housing member 22 than end 60 of housing member 22 and nearer to end 90 of housing member 24 than end 88 of housing member 24 while guide 40 is disposed between members 22, 24 nearer to end 60 of housing member 22 than end 58 of housing member 22 and nearer to end 88 of housing member 24 than end 90 of housing member 24. In other embodiments, additional guides may be located between members 22, 24. For example, additional guides may be mounted to, and disposed between, the corresponding longitudinal members 46, 48, 50 and 76, 78, 80 of frames 44, 74 of housing members 22, 24 and therefore located at the lateral ends of housing members 22, 24. These additional guides may again be nearer to one longitudinal end of each housing member 22, 24 than an opposite longitudinal end of the housing member 22, 24. In one embodiment in which box-like or rectangular prism frames are employed, a total of six guides are used in which three guides are disposed between corresponding upper longitudinal members or cross members of the frames of the housing members and three guides are disposed between corresponding lower longitudinal or cross members of the frame. In this embodiment, one of the three guides used between the upper longitudinal or cross members of the housing members is disposed proximate or on the lateral centerlines of the two housing members nearer to one longitudinal end of each housing member than an opposite longitudinal end of each housing member while the other two guides are disposed on opposite sides of the lateral centerlines of the two housing members nearer to the opposite longitudinal end of each housing member than the one longitudinal end of each housing member. The three guides used between the lower longitudinal or cross members of the housing members are similarly arranged. In another embodiment in which box-like or rectangular prism frames are employed, a total of four guides are used in which two guides are disposed between corresponding upper longitudinal members of the frames of the housing members and two guides are disposed between corresponding lower longitudinal members of the frame. In this embodiment, the four guides may be located in the same plane perpendicular to axes 42, 72.

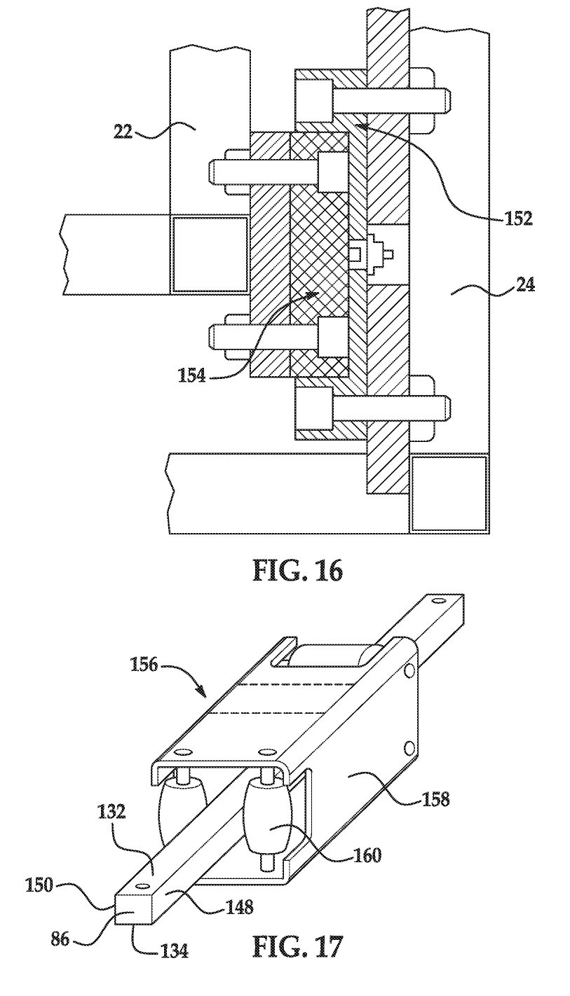

Referring to FIG. 15, in accordance with one embodiment, each of guides 38, 40 may include a pair of a pair of rollers 128, 130 fixed to one of housing members 22, 24 that are configured to engage corresponding roller surfaces 132, 134 formed in the other housing member 22, 24. In the illustrated embodiment, rollers 128, 130 are mounted to brackets 136 fixed to cross members 86 of housing member 24. The brackets 136 may orient the rollers 128, 130 so that the rollers 128, 130 are spaced both vertically and longitudinally relative to housing members 22, 24 and are configured to rotate about axes that extend laterally relative to housing members 22, 24 and parallel to one another. Each roller 128, 130 may comprise a wheel 138 configured to be received within, and rotate relative to, a hub 140 fixed to bracket 136. The roller surfaces 132, 134 engaged by rollers 128, 130 may be formed on opposite upper and lower sides of rails 68, 70 of housing member 22. Guides 38, 40 may alternatively, or in addition, include a pair of pins, such as pins 142, 144, fixed to one of housing members 22, 24 and configured to receive a rail, such as rail 68 or 70 fixed to the other housing member 22, 24. In the illustrated embodiment, pins 142, 144 are mounted to brackets 146 fixed to cross members 86 of housing member 24. Bracket 146 may orient pins 142, 144 so that pins 142, 144 are spaced laterally relative to housing members 22, 24 and configured to receive rail 68 or 70 therebetween such that pins 142, 144 engage lateral surfaces 148, 150 on opposite sides of rail 68 or 70. In accordance with one aspect of the present teachings, rollers 128, 130 and pins 142, 144 are both crowned such that the diameters of rollers 128, 130 and pins 142, 144 vary along the length of rollers 128, 130 and pins 142, 144 and the outer surface of rollers 128, 130 and pins 142, 144 have curved profiles. The crowned shape of rollers 128, 130 and pins 142, 144 permits relative movement of housing members 22, 24 in multiple degrees of freedom. In particular, while rollers 128, 130 and pins 142, 144 allow movement of housing members 22, 24 relative to one another in the longitudinal direction of housing members 22, 24 (i.e. along axes 42, 72), rollers 128, 130 and pins 142, 144 also permit housing members 22, 24 to rotate about the rotational axes of rollers 128, 130 and/or the center axes of pins 142, 144 such that the axes 42, 72 along which housing members 22, 24 extend may move from a normally parallel or coincident relationship to one in which the axes are oriented to intersect one another at an angle (relative to a vertical, horizontal, or other plane). Rollers 128, 130 and pins 142, 144 therefore each permit the angle of intersection of theses axes 42, 72 to vary to allow for changes in alignment between the drive shaft and driven shaft of the shaft coupling and their surrounding support structures including relative vertical movement, lateral movement and twisting of the housing members 22, 24. It should be understood that the guides 38, 40 could take alternative forms. For example, and with reference to FIG. 16, instead of rollers 128, 130 and pins 142, 144, one of members 22, 24 (member 24 in the illustrated embodiment), could include a carriage 152 configured to receive and ride on a rail 154 on the other of members 22, 24 (member 22 in the illustrated embodiment). Referring to FIG. 17, in another embodiment, a guide 156 includes a single mounting bracket 158 configured to surround rail 68 and in which a plurality of rollers 160 are mounted. Bracket 158 may be coupled to a cross member 86 of housing member 24 using conventional fasteners including bolts, screws, welds or adhesives. Bracket 158 may be tubular in shape and configured to surround rail 68. In the illustrated embodiment, bracket 158 is configured to mount four rollers 160 with two rollers disposed proximate one longitudinal end of bracket 158 engaging surfaces 132, 134 on opposite sides of rail 86 and two rollers (only one of which is shown) disposed proximate the opposite longitudinal end of bracket 158 engaging surfaces 148, 150 on opposite sides of rail 86. Rollers 160 may again be crowned such that the diameters of rollers 160 vary along the length of rollers 160 and the outer surface of rollers 160 have curved profiles. The crowned shape of rollers 160 permits relative movement of housing members 22, 24 in multiple degrees of freedom in the same manners as rollers 128, 130 and pins 142, 144.

A guard 20 for a shaft coupling in accordance with the present teachings is advantageous relative to conventional guards for shaft couplings. In particular, the guards 20 described herein provide protection to nearby individuals and equipment, but also facilitate access to the shaft coupling and surrounding equipment for maintenance. The guards 20 provide easy access to shaft couplings during operation of power transmission assemblies as well as during downtime for the assemblies. As a results the guards 20 are more likely to be used (thereby reducing risks associated with the power transmission assemblies), facilitate regular maintenance on the shaft couplings, and result in less downtime of power transmission assemblies during maintenance

While the invention has been shown and described with reference to one or more particular embodiments thereof, it will be understood by those of skill in the art that various changes and modifications can be made without departing from the spirit and scope of the invention.

What is claimed is:

1. A guard for a shaft coupling that couples a drive shaft disposed about a rotational axis and a driven shaft, the guard comprising:
a first housing member extending longitudinally along a first axis and having first and second longitudinal ends, the first longitudinal end defining an opening configured to receive one shaft of the drive shaft and the driven shaft;
a second housing member extending longitudinally along a second axis and having first and second longitudinal ends, the first longitudinal end of the second housing member defining an opening configured to receive another shaft of the drive shaft and the driven shaft, the second longitudinal end of the second housing member configured to be telescoped within the second longitudinal end of the first housing member, the second housing member movable relative to the first housing member in the direction of the first axis; and,
a plurality of guides disposed between and coupling the first and second housing members and configured to allow relative movement of the first and second housing members.

2. The guard of claim 1 wherein the first longitudinal end of the first housing member is disposed about an entirety of a perimeter of the one shaft and the first longitudinal end of the second housing member is disposed about an entirety of a perimeter of the another shaft.

3. The guard of claim 1 wherein the first longitudinal end of the first housing member is disposed about only a portion of perimeter of the one shaft and the first longitudinal end of the second housing member is disposed about only a portion of a perimeter of the another shaft.

4. The guard of claim 1 wherein a height of the first housing member varies along a length of the first housing member and a height of the second housing member varies along a length of the second housing member.

5. The guard of claim 1 wherein at least one of the first and second housing members is movable relative to the other of the first and second housing members in a direction that varies an angle of intersection between the first and second axes.

6. The guard of claim 1 wherein the plurality of guides includes:
a first guide disposed nearer to the first longitudinal of the first housing member than the second longitudinal end of the first housing member and nearer to the second longitudinal end of the second housing member than the first longitudinal end of the second housing member; and,
a second guide disposed nearer to the second longitudinal of the first housing member than the first longitudinal end of the first housing member and nearer to the first longitudinal end of the second housing member than the second longitudinal end of the second housing member.

7. The guard of claim 1 wherein at least one of the plurality of guides comprises a roller fixed to one of the first and second housing members and configured to engage a roller surface formed in another of the first and second housing members.

8. The guard of claim 1 wherein at least one of the plurality of guides comprises a rail fixed to one of the first and second housing members and a carriage fixed to another of the first and second housing members and configured to receive the rail.

9. The guard of claim 1, further comprising:
a first spring coupling the first housing member to a first fixed structure disposed nearer to the first longitudinal end of the first housing member than the second longitudinal end of the first housing member; and,
a second spring coupling the second housing member to a second fixed structure disposed nearer to the first longitudinal end of the second housing member than the second longitudinal end of the second housing member.

10. The guard of claim 1 wherein the first housing member is centered on the first axis and the second housing member is centered on the second axis and the first and second springs are disposed on opposite sides of the first axis and on opposite sides of the second axis.

11. A guard for a shaft coupling that couples a drive shaft disposed about a rotational axis and a driven shaft, the guard comprising:
a first housing member extending longitudinally along a first axis and having first and second longitudinal ends, the first longitudinal end defining an opening configured to receive one shaft of the drive shaft and the driven shaft;
a second housing member extending longitudinally along a second axis and having first and second longitudinal ends, the first longitudinal end of the second housing member defining an opening configured to receive another shaft of the drive shaft and the driven shaft, the second longitudinal end of the second housing member configured to be telescoped within the second longitudinal end of the first housing member, the second housing member movable relative to the first housing member in the direction of the first axis; and,
means for guiding movement of the second housing member within the first housing member.

12. The guard of claim 11 wherein the first longitudinal end of the first housing member is disposed about an entirety of a perimeter of the one shaft and the first longitudinal end of the second housing member is disposed about an entirety of a perimeter of the another shaft.

13. The guard of claim 11 wherein the first longitudinal end of the first housing member is disposed about only a portion of perimeter of the one shaft and the first longitudinal end of the second housing member is disposed about only a portion of a perimeter of the another shaft.

14. The guard of claim 11 wherein a height of the first housing member varies along a length of the first housing member and a height of the second housing member varies along a length of the second housing member.

15. The guard of claim 11 wherein at least one of the first and second housing members is movable relative to the other of the first and second housing members in a direction that varies an angle of intersection between the first and second axes.

16. The guard of claim 11 wherein the guiding means includes:
a first guide disposed nearer to the first longitudinal of the first housing member than the second longitudinal end of the first housing member and nearer to the second longitudinal end of the second housing member than the first longitudinal end of the second housing member; and,
a second guide disposed nearer to the second longitudinal of the first housing member than the first longitudinal end of the first housing member and nearer to the first longitudinal end of the second housing member than the second longitudinal end of the second housing member.

17. The guard of claim 11 wherein the guiding means includes a roller fixed to one of the first and second housing members and configured to engage a roller surface formed in another of the first and second housing members.

18. The guard of claim 11 wherein the guiding means comprises a rail fixed to one of the first and second housing members and a carriage fixed to another of the first and second housing members and configured to receive the rail.

19. The guard of claim 11, further comprising:
a first spring coupling the first housing member to a first fixed structure disposed nearer to the first longitudinal end of the first housing member than the second longitudinal end of the first housing member; and,
a second spring coupling the second housing member to a second fixed structure disposed nearer to the first longitudinal end of the second housing member than the second longitudinal end of the second housing member.

20. The guard of claim 11 wherein the first housing member is centered on the first axis and the second housing member is centered on the second axis and the first and second springs are disposed on opposite sides of the first axis and on opposite sides of the second axis
